(19) United States
(12) Patent Application Publication
(10) Pub. No.: US 2009/0026333 A1
(43) Pub. Date: Jan. 29, 2009

(54) Leveling and Support Device

(76) Inventor: John Lenzini, Denver, CO (US)

Correspondence Address: Leyendecker & Lemire, LLC, C/O PORTFOLIO IP, P.O. BOX 52050, MINNEAPOLIS, MN, 55402, US

(21) Appl. No.: 11/782,550

(22) Filed: Jul. 24, 2007

(51) Int. Cl. F16M 11/24

(52) U.S. Cl. 248/188.2

(57) ABSTRACT

A leveling device comprising one or more bracket sections, an integrated structure coupling mechanism, a brace section, and a leveler. The one or more bracket sections may have a top member with a substantially flat top side and a generally perpendicularly aligned side member. The brace section may comprise a top surface substantially planar to the bracket section top side and extending one of away from and between the one or more bracket sections, a substantially flat bottom surface, and an angled bore. The leveler may comprise an angled nut and bolt.

### FIELD OF THE INVENTION

This invention generally relates to surface leveling devices.

### BACKGROUND

Shims are thin pieces of material, often tapered, used during construction and wood-working projects, among other areas, to fill small gaps and spaces between objects. Shims may be used to fill gaps between parts that are subject to wear, to support one or more objects, to adjust for a better fit between objects, or to level a surface of an object. Shim materials may be comprised of wood, stone, metal, or even paper. Other materials may also be used. High quality shim stock may be used in commercial applications comprising a laminated polymeric shim.

When used as a leveler, one type of surface that a shim may be used to level is a counter top. Oftentimes, during construction of a building, cabinets are built and a counter top is placed on them in an area such as, but not limited to, a kitchen area or a bathroom. Upon placement of the counter top on a cabinet frame, shims may be placed between the counter top and a top surface of the cabinet frame in order to raise an end of the counter top above the frame, if that portion of the counter top is lower than other portions of the counter top. Multiple shims may be used, depending on the distance that the counter top must be raised to make the counter top end level.

Unfortunately, it is difficult to permanently secure prior art shims in place when employing such a shim-leveling technique. Prior art shims have no mechanism to adequately secure the shim to the counter top and the cabinet; therefore the shims may become disengaged from the counter top and cabinet after being placed in location upon leveling the counter top. Shim disengagement may occur through use of the cabinet and countertop, wherein when the cabinet doors are opened and closed or items are placed on the countertop, vibration occurs within the shims, loosening the shim slightly from their location between the counter top and cabinet until eventually they are loosened far enough that the shim may fall out of place.

Besides having shims fall out of position and create an unstable and/or unleveled surface, leveling a countertop using shims takes a great deal of time. By continually placing different thickness shims in different locations where the counter top and the cabinet sides meet, the countertop may be leveled, but it takes a great deal of time to perform correctly. In the case of a granite or slab counter top, using shims may cause a portion of the countertop to be unsupported, causing undue stress on the counter top, causing the counter top to break, crack, or otherwise fail. When a person is required to spend a great deal of time on leveling a counter top and ensuring the counter top is properly supported during construction or a remodeling of building, time is taken away from that person or other persons performing other jobs around the site, thereby increasing the costs of the project and decreasing the overall profit. Especially in custom-built homes, this can create a loss in the thousands of dollars per home.

### SUMMARY OF THE DRAWINGS

FIG. 1 is an isometric view of a corner version of a leveling device showing the structure coupling mechanism in dashed-lines according to one embodiment of the invention.

FIG. 2A is a top view of a corner version of a leveling device according to one embodiment of the invention.

FIG. 2B is a front view of a corner version of a leveling device along view a-A of FIG. 2A, according to one embodiment of the invention.

FIG. 3 is an isometric view of a sidewall version of a leveling device having a brace section with a U-shaped cross section and showing the structure coupling mechanism in dashed-lines according to one embodiment of the invention.

FIG. 4A is a top view of a sidewall version of a leveling device according to one embodiment of the invention.

FIG. 4B is a front view of a sidewall version of a leveling device according to one embodiment of the invention.

FIG. 4C is a side view of a sidewall version of a leveling device according to one embodiment of the invention.

FIG. 5 is an isometric exploded view of a corner version, a sidewall version, a structure frame portion and a leveling surface portion.

FIG. 6 is an isometric view of a corner leveling device version coupled to a support structure with a leveling surface placed on the leveling device, the leveling surface having a cut-away portion showing a portion of the leveling device bracket section, brace section, and leveler, the leveler bolt contacting a bottom side of the leveling surface.

### DETAILED DESCRIPTION

One embodiment of the invention is comprised of a leveling device adapted to couple to a structure such as, but not limited to, a cabinet frame, and enable quick leveling of a surface such as, but not limited to, a countertop. An embodiment of a leveling device may be comprised of at least one bracket section, a brace section, an integrated structure coupling mechanism, and a leveler. One embodiment version may be comprised of a corner leveling device version and an embodiment may be a sidewall leveling device version.

One corner leveling device version is comprised of two bracket sections having generally straight, perpendicularly-aligned longitudinal axis integrated or coupled to the brace section. A corner version brace section may extend between the two bracket sections. A bracket section may have a top member with a substantially flat top side, substantially planar to a top surface of the brace section. In one embodiment, the bracket section top member may also have a bottom side. The bracket section may have a side member perpendicularly integrated or coupled to the top member. The bracket section may be coupled or integrated at a side member edge and at a top member edge, respectively. One bracket section side member length and width may be generally equal to a top member length and width.

Another embodiment may be comprised of a sidewall leveling device version. In one sidewall leveling device version the at least one bracket section may be a single bracket section having a generally straight longitudinal axis. The bracket section may be integrated or coupled to the brace section. One brace section may generally bisect the bracket section, extending away from the bracket section, where the brace section top surface may be substantially planar to the bracket section top member top side. Unlike the corner version, where the bracket section side member length and width are generally equal to the top member length and width, in one sidewall version, the bracket top member length may be generally greater than to the bracket side member width, and the top member width may be less than the side member length.

As far as the structure coupling mechanism, in one embodiment, the structure coupling mechanism may be integrated to the one or more bracket sections or the brace section and may be adapted to pierce a structure surface. For example, in one embodiment, the structure coupling mechanism may be comprised of a portion of the top member of the bracket section partially cut away from the top side in a generally pointed triangular manner and bent downwardly along an edge of the triangular structure coupling mechanism so a pointed portion extends below a top member bottom side. Such a structure coupling mechanism may be referred to as “teeth”. By coupling the leveling device to the support structure, the teeth help the leveling device from falling out of place like conventional shims. Therefore, the leveling device helps to keep counter tops and other leveling surfaces level over a longer period of time than conventional shims.

One embodiment's leveler may be comprised of a bolt and a nut. The nut in one embodiment may be welded to the brace section on a brace section bottom surface, with the nut bore generally centered on a brace bore. The bore of one nut may have a longitudinal axis which may not be perpendicularly aligned with the brace section bottom surface. The bolt may be adapted to screw into the nut and extend through the brace bore past the brace section top surface.

In one method of leveling a surface, a leveling device having the one or more bracket sections, the integrated structure coupling mechanism, the brace section, and the leveler may be used. The method may be comprised of placing the leveling device on a structure top surface. One type of structure that the leveling device may be placed on is on top of a cabinet frame. In one method, a corner version is used where the structure coupling mechanism is at least one integrated tooth extending below a bracket top member bottom side. A leveling device may be placed in the corner of the cabinet frame with the teeth being placed on the frame top surface. The teeth may then be inserted into the structure top surface by striking the bracket section proximal the teeth location with a mallet or a hammer in a downward motion adapted to push the teeth into the top of the frame. A similar method may be used to couple a sidewall leveling device version to the frame, except that the leveling device and the one or more teeth may be placed on one side of a cabinet frame instead of on two sides of a corner.

Upon coupling a leveling device to the structure top surface, one method may include placing a leveling surface such as, but not limited to, a countertop, on the leveling device. In one embodiment, a countertop may be placed on the top side of the top member of the leveling device bracket section. A method may be comprised of measuring a leveling angle of a top side of the countertop. The leveling angle may be measured by using a bubble level tool. If the counter top is raised higher at one end than at another end, in one method, the leveler is adjusted.

One method may employ a leveler to adjust the height of the counter top which comprises a bolt. The bolt may be inserted into a bore located on the brace. In one embodiment, centered about the bore may be a nut welded to the brace. As the bolt is screwed into and through the nut, it enters and passes through the bore, exiting the bore and coming into contact with the countertop bottom surface. The countertop may then be raised by continuing to turn the screw and raising the screw through the nut and bore, thereby raising and leveling the surface. A method may also include coupling the countertop to the structure. Through a method of leveling a surface such as, but not limited to, a counter top, the method employing the use of a leveling device to leveling the surface, the time needed to level the surface is decreased over the time needed to level a surface when employing conventional shims.

### Terminology:

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “couple” or “coupled” as used in this specification and the appended claims refers to either an indirect or direct connection between the identified elements, components or objects. Often the manner of the coupling will be related specifically to the manner in which the two coupled elements interact.

The term “integrate” or “integrated” as used in this specification and the appended claims refers to a blending, uniting, or incorporation of the identified elements, components or objects into a unified whole.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of ±20%. Also, as applicable, the term “substantially” as used herein unless otherwise indicated means a margin of ±10%. It is to be appreciated that not all uses of the above terms are quantifiable such that the referenced ranges can be applied.

### One Embodiment of a Leveling Device

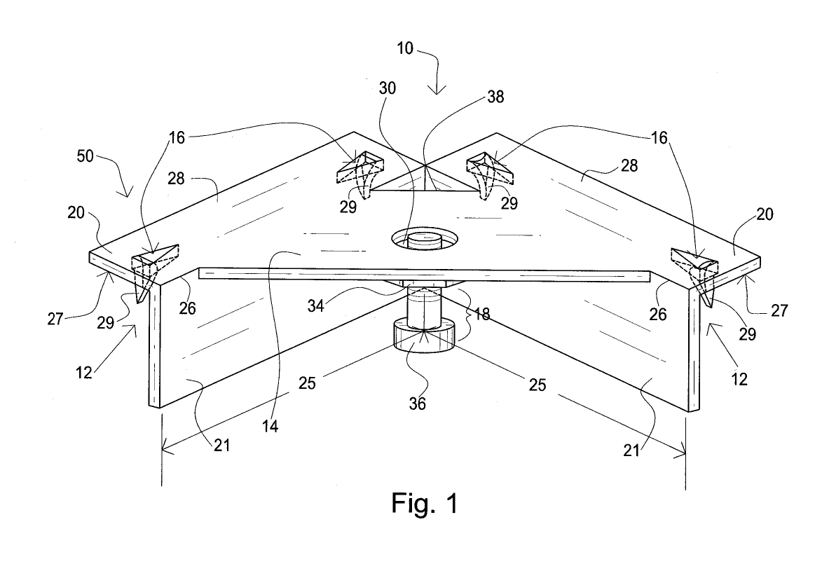

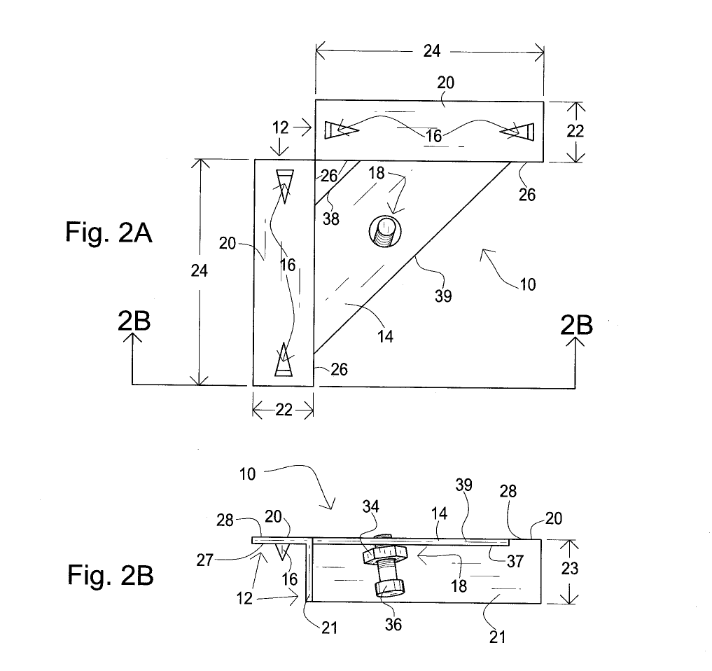

As best shown in FIGS. 1 through 4C, one embodiment of a leveling device 10 is comprised of one or more bracket sections 12, a brace section 14, an integrated structure coupling mechanism 16, and a leveler 18. The bracket section of one embodiment may be referred to as an L-section in one embodiment and the brace section may be referred to as a plate. The bracket section 12 may be comprised of a top member 20 and a side member 21. The top member may be referred to a vertical member and the side member may be referred to as a horizontal member in one embodiment. As best shown in FIGS. 1 through 2B, the top member and side member may be generally rectangular in shape and have generally similar shapes. For example, a top member width 22 may generally equal a side member width 23. Likewise, a side member length 25 may be generally equal to a top member length 24.

Additionally, in one embodiment, the side member 21 and top member 20 may be generally perpendicularly aligned. The two members may be integrated members, and in other embodiments, the two members may be coupled. In fact, all parts and sections of a leveling device may be integrated or coupled, depending on the particular embodiment.

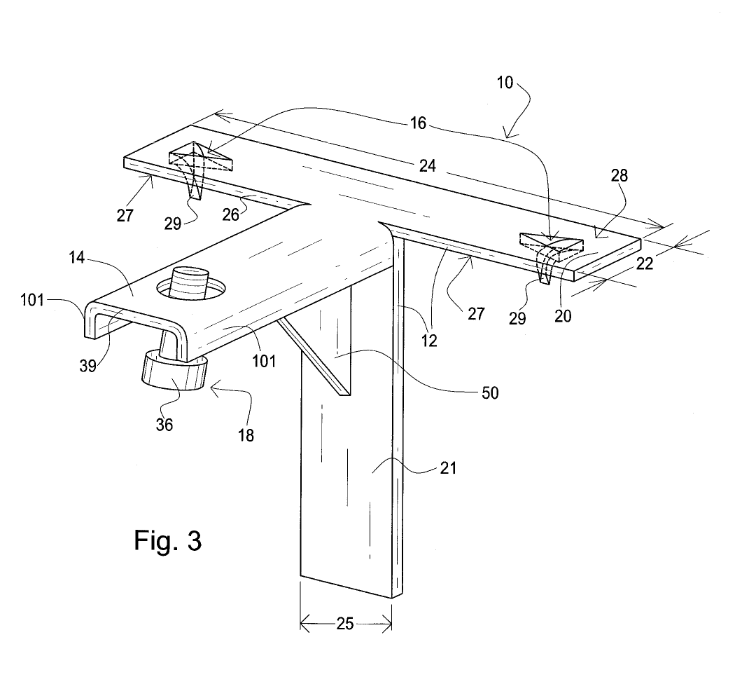

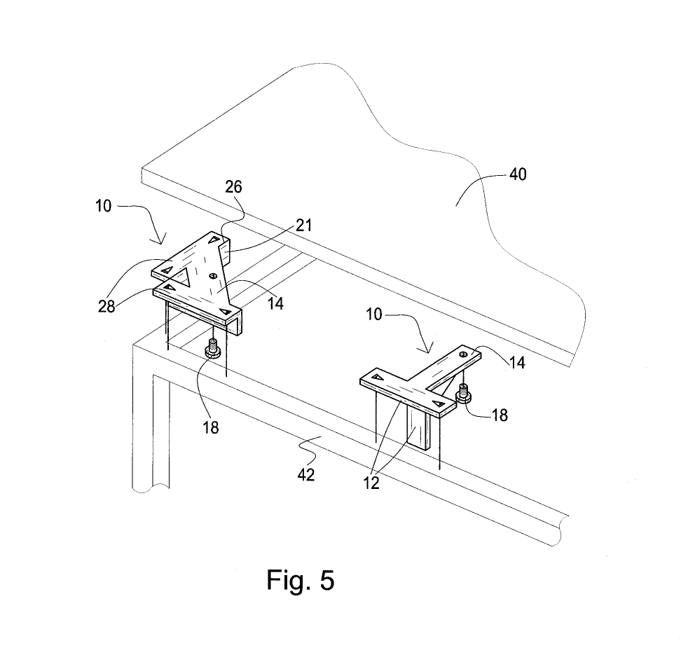

As shown in FIGS. 1 and 3, one leveling device 10 top member 20 is integrated to the side member 21 along a lengthwise edge 26. However, in other embodiments, the side member may integrate or couple to the top member along a top member bottom side 27 or in any other top member location. The top member in one embodiment may also have a top side 28. The top side may be substantially flat to allow a leveling surface such as, but not limited to, a countertop, to rest on the top side, as best shown in FIG. 5.

A feature integrated to one embodiment's bracket section 12 top member 20 may be the structure coupling mechanism 16. One structure coupling mechanism may be comprised of a pointed extension. The structure coupling mechanism may be coupled to the top member in one embodiment, or may be integrated or coupled to the side member or the brace section 14. The structure coupling mechanism may be integrated or coupled to multiple embodiment sections. As best shown in FIGS. 1 and 3, the structure coupling mechanism may be comprised of a set of teeth 29. The teeth may be adapted to pierce a structure 42 surface (as best shown in FIG. 5). An embodiment may have at least one tooth, or may include a plurality of teeth such as, but not limited to, 4 teeth. One embodiment's side member may be adapted to rest against a side portion of the structure.

In one embodiment, the teeth 29 may be a portion of the bracket section 12 partially cut away from the top member 20, extending downwardly from the top side 28 and extending past the bottom side 27. As best shown in FIGS. 1 and 3, the cut away portion of the bracket section may be generally triangularly-shaped. In one embodiment, two sides of the triangle may be cut or stamped on the top member, with the structure coupling mechanism bending downward along the third edge of the triangle. An embodiment may be laser cut or laser developed or designed as well. In one embodiment, the structure coupling mechanism generally resembles an isosceles triangle, with the structure coupling mechanism bending downwardly along the base of the triangle. A portion of the teeth may extend past the top member bottom side.

In an embodiment such as, but not limited to, a corner embodiment, as shown in FIGS. 1 through 2A a first bracket section 50 is substantially perpendicularly aligned with a second bracket section 52. Non-perpendicularly aligned bracket sections ion corner versions are also contemplated. The brace section 14 may extend between the first and second bracket sections. The brace of one embodiment may have a top surface which is substantially level with the top side 28 of the bracket section 12 top member 20. The thickness of the brace section may be about equal to the thickness of the bracket section. Additionally, the brace section may be integrated to the one or more bracket sections. One brace section may integrate to a bracket section along the lengthwise edge 26. In a brace section that is coupled to the bracket section, spot welds may be used to couple the two tighter, with the spot welds located on the brace or bracket section bottom surfaces or sides. Additionally, stitch welding may be used to couple the bracket sections together or the bracket sections to the brace section. As best shown in FIG. 3, one brace section may have cross-section which is generally U-shaped. One U-shaped brace may have sidewalls 101. A sidewall thickness may be as thick as a brace section top member or side member in one embodiment.

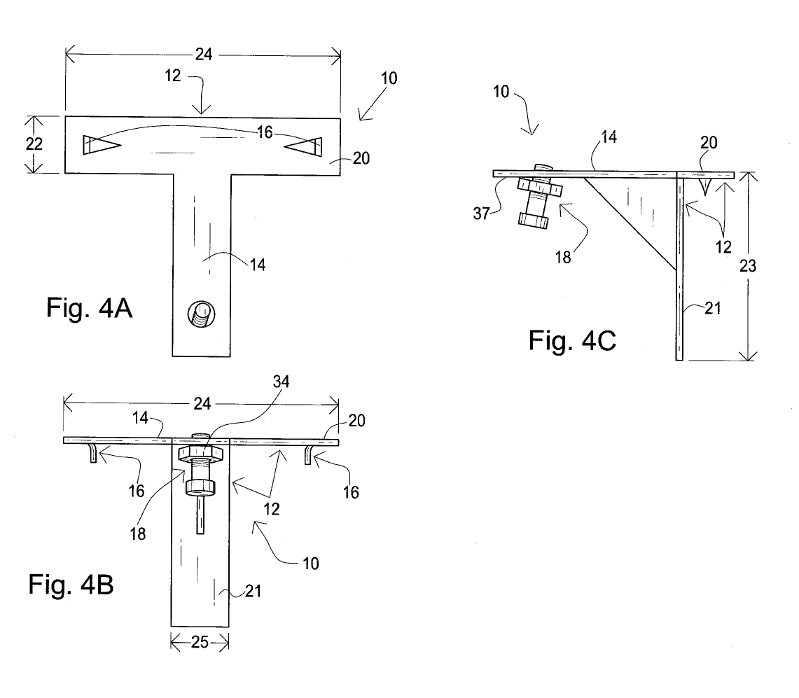

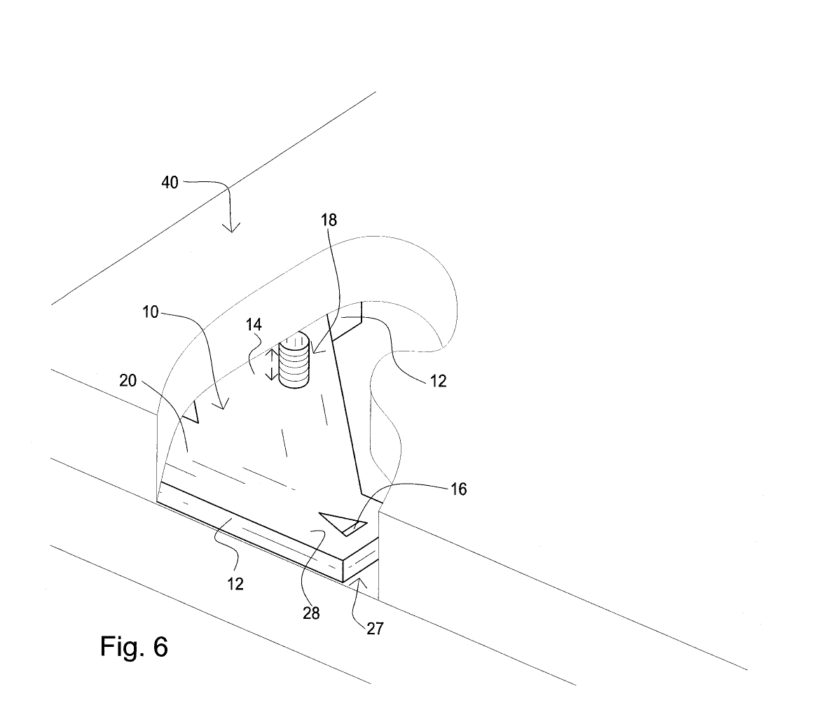

A brace section 14 may also be comprised of a brace section bore 30. The bore may allow for a portion of a leveler 18 to contact a leveling surface 40, as best shown in FIGS. 5 and 6. In one embodiment, the leveler may be comprised of a threaded female portion such as, but not limited to, a nut 34 and a threaded male portion such as, but not limited to, a bolt 36. One bolt head may be comprised of a socket head reception port such as, but not limited to, an Allen Bolt reception port, which may be a hexagonally-shaped bolt head. One brace section bore may be generally centered along a brace section leading edge 38 or trailing edge 39. In one corner version, a leading edge may create an acute angle with the lengthwise edge 26 and a trailing edge may create an obtuse angle with the lengthwise edge, as best shown in FIG. 2A Additionally, the bore may be located nearer the trialing edge than the leading edge in one corner version and may be closer to the trailing edge than the bracket section/brace section integration or coupling location in one sidewall embodiment. The location of the bore on the brace section in one embodiment is best represented in FIGS. 2A and 4A. The bore may be located in different areas such as, but not limited to, other brace section locations; a bracket section location is also contemplated.

The leveler nut 34 is comprised of a threaded bore, the bore having a longitudinal axis. The nut may be welded to a brace section bottom surface 37. As best shown in FIG. 2B, in one embodiment, the longitudinal axis of the leveler nut 34 may not be aligned perpendicularly to the brace section 14 bottom surface. For example, in one embodiment, the longitudinal axis of the nut may create about a 5 degree angle with the brace section bottom surface or may even have a 10or 15 degree angle in other embodiments. The angle may allow a person to access the bolt or nut in order to tighten and loosen the leveler. The nut may be a 5/16 in nut in one embodiment and a bolt may be a 5/16 hex bolt. One embodiment's nut may be angled towards the trailing edge 39 wherein the nut bore slightly faces and opens up towards the trailing edge. In angling the nut towards the trailing edge, the bolt 36 will insert into the nut at generally the same angle −5 degrees in one embodiment, allowing the bolt head to slightly face the trailing edge as well. Having a bolt angled toward the trailing edge enables easier access to the bolt for a person tightening the bolt through the nut and brace section bore 30 upon installation of the device onto a structure 42.

As best shown in FIGS. 5 and 6, if the nut bore longitudinal axis and the bolt were generally perpendicularly aligned with the brace section bottom surface, upon installation of the leveling device, without an angled nut and bolt combination, the bolt-head may be difficult to reach. In other embodiments, the bore may be threaded, angly so or otherwise, and a nut may not be coupled to or integrated to the leveling device as part of the leveler. The bolt 36 in one embodiment may be adapted to screw into and out of the nut 34, extend into and out of the bore 30, and contact a leveling surface 40, as best shown in FIGS. 5 and 6.

One embodiment of a leveling device 10 may be a sidewall version, as best shown in FIG. 3 through 4C. As previously discussed, a sidewall version may operate in substantially the same way, and is designed generally similarly as the corner version shown in FIGS. 1 through 2B. For example, one sidewall version may be comprised of a bracket section 12, a brace section 14, and a leveler 18. Differences between a sidewall version and a corner version may include a sidewall version having a single bracket section instead of two bracket sections, and may be further comprised of a support member 50.

Unlike a corner version, as best shown in FIGS. 3, 4A, and 4C, in a sidewall version the length 24 and width 22 of a bracket section 12 top member 20 may not substantially equal the length 23 and width 25 of a bracket section side member 26. The length of the top member in one sidewall embodiment may be larger than the width of the top member and the width of the side member may be larger than the length of the side member. Additionally, the length of one side member may be generally equal to the width of a top member and the length of a top member may be at least as long as the width of one side member. The longitudinal axis of a bracket section 12 in one sidewall version, as well in one corner version may be measured lengthwisely and not widthwisely.

Similar to a corner version, a sidewall version's brace section 14 may have a top surface which is generally planar to the top side 28 of the top member 20. Additionally, the brace section top surface and the bracket section top member create a generally perpendicular angle with a side member 21. A sidewall version may have a brace section which extends away from the bracket section 12, as best shown in FIG. 3 instead of between two bracket sections, like a corner version. The brace section of a sidewall version may be additionally supported by a support member 50 and may generally bisect a sidewall version bracket section.

One support member 50 may be a generally triangularly-shaped sheet extending between the bottom surface 37 of the brace section and the side member 21. The brace section may also have a leveler 18 which is comprised of an angled nut 34 and bolt 36, similar to the corner version. Non angled levelers are also contemplated.

A leveling device may be comprised of a metal such as, but not limited to, aluminum, an aluminum alloy, or any other type of metal such as steel or a steel alloy. An embodiment may be comprised of 18-20 gauge stainless steel. Polymeric and composite leveling device, among other materials, are also contemplated.

### One Method of a Leveling and Supporting a Surface:

As best shown in FIGS. 5 and 6, one method of leveling a surface 40 such as a counter top, or supporting a substantially rigid surface such as granite, comprises using a leveling device 10 comprising one or more bracket sections 12, an integrated structure coupling mechanism 16, a brace section 14, and a leveler 18. One method may incorporate a bracket section comprised of a top member 20 and a side member 21. The top member may include a top side 28 and a bottom side 27. In one method, the bottom side may be placed on a structure 42. For example, one method includes placing the bottom side on a top surface of a cabinet or countertop frame. Other structures, such as, but not limited to, cabinet walls, may also be used in one method. A method may include placing the leveling device in a structure corner or on a structure side.

Upon placing the bottom side 27 (or in other method, any other portion of the leveling device 10) on the structure, a method may also include coupling the leveling device 10 to the structure 42. One method of coupling the leveling device to the structure includes piercing a structure surface. For example, in one method, an embodiment's structure coupling mechanism 16 may be at least one generally triangularly-shaped partially cut-away portion of the top member 20 adapted to pierce the structure. This structure coupling mechanism may be cut along two sides of a generally-shaped isosceles triangle, with the triangular angled downwardly along an uncut third triangle side, which may be the base of the isosceles triangle. The point of the triangular structure coupling mechanism may extend past the top member bottom side 27.

In one method, the pointed integrated structure coupling mechanism 16 may pierce the top side of the structure 42 as the bottom side 27 of the top member 20 is placed on the structure and the integrated structure coupling mechanism is pressed through the structure top side in one method. The one or more triangularly-shaped pointed portions of the top member may be referred to as one or more teeth adapted to pierce the structure. Other coupling mechanisms such as, but not limited to, clasping mechanisms, adhesives, or any other coupling mechanism may be used in one method to couple the leveling device 10 to the structure. One method may couple the leveling device 10 to the structure 42 by use of a tool. For example, after the teeth are placed on the structure top surface, a hammer, mallet, or any other suitable tool may be used to strike the top member 20 top side 28 proximal the structure coupling mechanism 16 in order to force the teeth into the structure's top surface.

Upon placing the leveling device 10 in a structure corner or a structure sidewall and coupling the leveling device to the structure, a method of leveling a surface 40 using a leveling device 10 may also include placing the leveling surface 40 on the leveling device. For example, in one method, the leveling surface may be place on the top side 28 of the top member 20. It is contemplated that the leveling surface such as, but not limited to, a countertop, may be placed on other leveling device portions or sections. In one method, a countertop may be placed and coupled to the top member top side. A method may also include coupling the leveling surface to the structure at this point.

Upon placing and the leveling surface 40 on the leveling device 10 and coupling the surface to the device and the structure 42, adjusting the leveler 18 may be the next step in one method. For example, upon installation of a frame structure and a countertop in one method, the installer may measure the leveling angle of the countertop. A bubble level tool may be used to perform this step, although other level tools such as, but not limited to digital level tools may be used. In one method, an installer may find that upon performing the step of measuring the leveling angle of the leveling surface that the surface may be found not to be leveled, and may be angled towards or away from a corner or a sidewall where a leveling device is installed.

If the leveling surface 40 falls towards or away from a corner or a sidewall location where a leveling device 10 is installed, in one method, the leveler 18 may need to be adjusted in order to raise or lower the portion of the leveling surface, similar to inserting and removing shims. One leveler may be comprised of a nut 34 and a bolt 36. The nut may be coupled to the brace section and the bolt may rotate into and through the nut and a brace section bore.

In one method, the bolt 36 may be rotated to adjust the height of the leveling surface 40. For example, if the bolt is rotated into the nut and through a bore located in the brace section 14, the bolt extends through the brace section, contacting a leveling surface bottom side. The bolt may continued to be rotated and raised through the brace section or any other leveling device 10 portion the nut is coupled or integrated to or that has a threaded bore. In doing so, when the bolt contacts the leveling surface, the countertop or other surface is raised to a level that enables the top side of the leveling surface to be a level surface. One leveler may have a locking mechanism adapted to allow an installer to lock the bolt at a certain height.

I claim:

1. A countertop leveling and support device comprising,
one or more bracket sections having a top member and a side member, the top member having (i) a substantially flat top side and (ii) an integrated structure coupling mechanism comprising a pointed extension generally extending downwardly from a bracket section top member;
a brace section comprising (i) a top surface substantially planar to the bracket section top side and extending one of away from and between the one or more bracket sections, (ii) a substantially flat bottom surface, and (iii) a bore; and
a leveler comprising a threaded male component and a threaded female component.

2. The leveling and support device of claim 1 wherein,
the side member is generally perpendicularly aligned to the top member;
the structure coupling mechanism being integrated to at least one of the one or more bracket sections;
the brace section further comprises an integration to the bracket section; and
the leveler comprising a bolt and a nut.

3. The leveling arid support device of claim 2 wherein,
each of the leveler nut and bolt comprising (i) centers generally concentric with a bore center and (ii) a longitudinal axis non-perpendicularly aligned to the brace section bottom surface; and
the bolt being adapted to (i) screw into and out of the nut, (ii) extend into and out of the bore, and (iii) contact a leveling surface.

4. The leveling and support device of claim 2 wherein, the bracket section is unified to the brace section along a lengthwise edge.

5. The leveling and support device of claim 1 wherein,
the one or more bracket sections comprising one bracket section having a generally straight longitudinal axis,
a length of the bracket section side member being about equal to a width of the bracket section top member;
a length of the bracket section top member being at least as long as a width of the bracket section side member;
the brace section generally bisecting the bracket section; and
further including a gusset support member extending between the brace section and the bracket section.

6. The leveling and support device of claim 1 wherein,
the one or more bracket sections comprising a first bracket section and a second bracket section,
each bracket section having a longitudinal axis, the longitudinal axis of the first bracket section substantially perpendicularly aligning with the longitudinal axis of the second bracket section.
a length of each bracket section side member generally equaling a length of each bracket section top member;
a width of each bracket section side member generally equaling a width of each bracket section top member;
the first bracket section side member integrating with the first bracket section top member;
the second bracket section side member integrating with the second bracket section top member; and
the brace section (i) having a leading edge and (ii) extending between the first bracket section and the second bracket section, the leading edge creating an acute angle with the side member of the first and second bracket sections.

7. The leveling and support device of claim 1 wherein, the structure coupling mechanism comprising a bracket section portion adapted to pierce a structure surface.

8. The leveling and support device of claim 7 wherein, the structure coupling mechanism further comprises at least one generally pointed bracket section portion extending outwardly from a bracket section top member bottom side.

9. A method of leveling and supporting a surface using the leveling device of claim 1 comprising,
placing a bracket section top member bottom side on a structure top surface;
coupling the leveling device to the structure;
placing a leveling surface on the bracket top member top side; and
adjusting the leveler.

10. The method of claim 9 wherein, said placing the bracket section top member bottom side on a structure top side comprises,
placing the bracket in one of structure corner and a structure sidewall; and
setting the integrated structure coupling mechanism on the structure top side.

11. The method of claim 9 wherein, said adjusting the leveler includes
turning a bolt placed through a bore in the brace section;
contacting the leveling surface with the bolt; and
supporting the leveling surface.

12. The method of claim 9 further including,
placing the leveling surface on the brace section top surface;
measuring a leveling angle of a leveling surface top side; and
coupling the leveling surface to the structure.

13. The method of claim 9 wherein,
the integrated structure coupling mechanism comprises a portion of the bracket section; and
said coupling the leveling device to the structure includes inserting a portion of the structure coupling mechanism into the structure by piercing a structure surface.

14. The method of claim 13 wherein,
the portion of the structure coupling mechanism inserted into the structure comprises a coupling mechanism tooth;
said inserting a portion of the structure coupling mechanism into the structure comprises (i) partially placing at least one coupling mechanism tooth into the top side of a cabinet frame arid (ii) striking the bracket section in a manner adapted to at least partially insert the at least one tooth into the wall.

15. A combination comprising,
a cabinet frame;
a counter top comprising one of slab or granite adapted to couple to at least one of a top and a side of the cabinet frame; and
at least one leveling device comprising,
one or more bracket sections;
an integrated structure coupling mechanism;
a brace section comprising a bore; and
a leveler.

16. The combination of claim 15 wherein,
the one or more bracket sections include a first bracket section and a second bracket section generally perpendicularly aligned to the first bracket section, each of the first and second bracket sections having a top member and a side member;
the structure coupling mechanism comprising a portion of at least one bracket section adapted to pierce the cabinet frame;
the brace section generally extending between the first bracket section and the second bracket section and having a brace section bore with a longitudinal axis non-perpendicularily-alligned with at least one of a brace section bottom surface and a brace section top surface; and
the leveler comprising a bolt and one of a threaded brace section bore and a nut, the bolt having a rounded bolt end.

17. The combination of claim 15 wherein, the at least one leveling device comprises a corner leveling device and a sidewall leveling device,
the corner leveling device further comprising,
a first bracket section and a second bracket section generally perpendicularly aligned and each having a top member and a side member, the side member integrated to the top member at a leading edge;
a structure coupling mechanism having a portion of at least one bracket section adapted to pierce the cabinet frame;
a brace section generally extending between the first bracket section and the second bracket section; and
a leveler comprising a bolt and one of a threaded brace section bore and a nut, the brace section bore having a longitudinal axis non-perpendicularly-aligned with at least one of a brace section bottom surface and a brace section top surface; and
the sidewall leveling device further comprising,
a single bracket section comprising,
a top member length,
a top member width,
a side member length being shorter than the top member length,
a side member width being longer than the top member width,
a brace section generally bisecting the bracket section and further comprising a support member.

18. A method of leveling a counter top comprising;
building a counter top support structure;
coupling a leveling device to the support structure, the leveling device comprising,
one or more bracket sections,
an integrated structure coupling mechanism,
a brace section comprising a bore, and
a leveler;
placing the counter top on the leveling device;
adjusting the leveler.

19. The method of claim 18 wherein,
said building a counter top support structure comprises erecting a cabinet frame;
said coupling the leveling device to the support structure includes inserting a portion of the leveling device into a top surface of a counter top; and
further including,
measuring a counter top leveling angle;
placing a second portion of the leveling device against the support structure.

20. The method of claim 19 wherein,
said measuring a leveling angle comprises using a bubble level tool;
said adjusting the leveler includes one of raising or lowering the counter top to; and
further including, locking a bolt in a level position.
